(19) United States
(12) Patent Application Publication
(10) Pub. No.: US 2005/0283424 A1
(43) Pub. Date: Dec. 22, 2005

(54) Factored cost bidding

(76) Inventors: David M. Wong, Sunnyvale, CA (US); Yuan Shan Tung, San Jose, CA (US); Winston Li, San Jose, CA (US)

Correspondence Address: FISH & RICHARDSON, P.C., PO BOX 1022, MINNEAPOLIS, MN, 55440-1022, US

(21) Appl. No.: 10/873,412

(22) Filed: Jun. 22, 2004

(51) Int. Cl. G06F 17/60

(52) U.S. Cl. 705/37

(57) ABSTRACT

A system may enable factored cost bidding to allow purchasers to favor or handicap bidders by automatically weighting the bidders' bids by factored assigned to the bidders based on collateral costs associated with doing business with the particular bidders. The factors may be adders and/or multipliers which may be used to normalize bids for display to the purchaser. The factors assigned to other bidders may be applied to the normalized current bid to generate a transformed bid for display to the other bidders.

### BACKGROUND

In electronic commerce, dynamic systems for commercial transactions provide a number of advantages not available in static systems. In general, a dynamic system is one in which the characteristics of potential transactions, as well as the universe of available transactions, may change over time. An online auction is an example of a dynamic system. In contrast, a static system is one in which the characteristics of a potential transaction generally do not change. An offer to sell a product at a fixed price on a company's web site is an example of a static system.

Conventional dynamic systems for commercial transactions, such as online auction sites, generally provide companies or other entities with an efficient avenue for buying and selling goods and services. For example, an auction may be opened to a much wider range of participants when conducted online. However, conventional online systems tend to be limited in flexibility, security, and/or functionality.

For example, conventional online systems may only provide the unit price to the auction participants. However, the unit price may be only one of many factors considered by purchasers when making a sourcing decision. Purchasers may also need to take into account other factors such as shipping costs, taxes and tariffs, the supplier's reputation and history of on-time delivery, product quality, etc.

### SUMMARY

A system may enable factored cost bidding to allow purchasers to favor or handicap bidders by automatically weighting the bidders' bids by factors assigned to the bidders based on collateral costs associated with doing business with the particular bidders. The factors may be adders and/or multipliers which may be used to normalize bids for display to the purchaser. The factors assigned to other bidders may be applied to the normalized current bid to generate a transformed bid for display to the other bidders.

The system may include a normalization module to multiply the bid by a multiplier assigned to a bidder and/or add an adder value assigned to the bidder to the bid to generate a normalized value for presentation to the purchaser. The normalization module may also subtract an adder value assigned to another bidder to the normalized value and/or divide the normalized value by a multiplier assigned to the other bidder to generate a transformed value for presentation to the other bidder.

### BRIEF DESCRIPTION OF THE DRAWINGS

FIG. 1 is a block diagram of a networked computer system supporting factored cost bidding.

FIG. 2 illustrates an auction object format.

FIG. 3 is a block diagram illustrating normalizing and transforming values in a factored cost bidding system.

FIG. 4 shows a case in which negative/positive adders are used to favor/handicap bidders.

FIG. 5 shows a case in which positive multipliers are used to handicap bidders.

FIG. 6 shows a case in which both adders and multipliers are used to favor/handicap bidders

FIG. 7 shows views for auction participants in an exemplary auction employing factored cost bidding.

### DETAILED DESCRIPTION

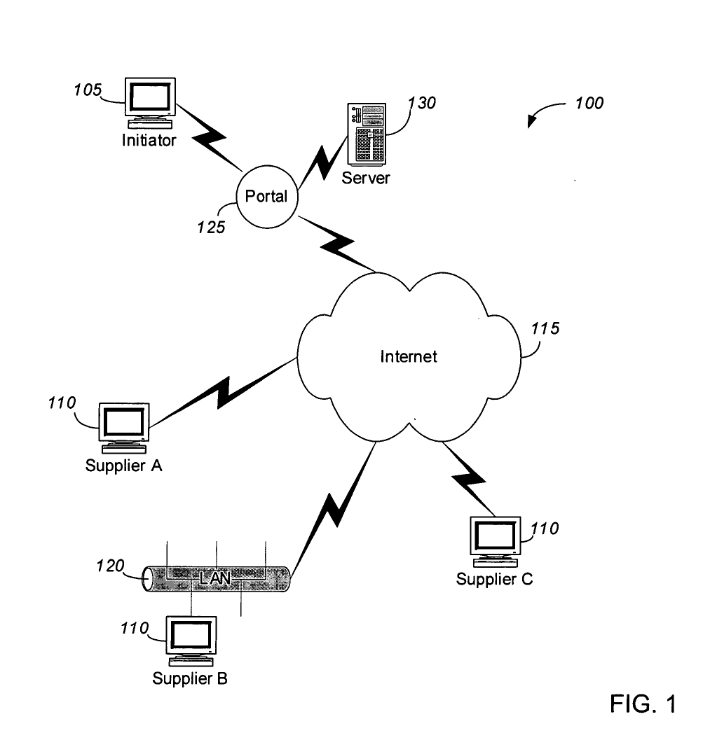

FIG. 1 illustrates a networked computer system 100. The system may include client computers at an initiator site 105 and supplier sites 110 which communicate over the Internet 115. The client computers may be connected to the Internet through other networks (e.g., local area networks 120 (LANs) or intranets) and/or a portal 125.

An initiator, e.g., a potential purchaser of goods and/or services, can use an online auction application to create an auction event on which potential suppliers may place bids. The initiator may be a human operator interacting with software running on a computer system, or an automated software process executing without human intervention, or various combinations of both. The online auction may reside, at least partially, at the initiator site 105 and/or a server 130.

The auction events created using the online auction application are reverse auctions. A reverse auction is an auction that uses the bid-down principle, in which the price being bid descends during the auction and the lowest bid is the winning bid. In general, the bidders are sellers or suppliers of goods or services who are offering to supply the requested good or service at the bid price. A reverse auction can provide buyers with significant cost savings by better leveraging competition among suppliers.

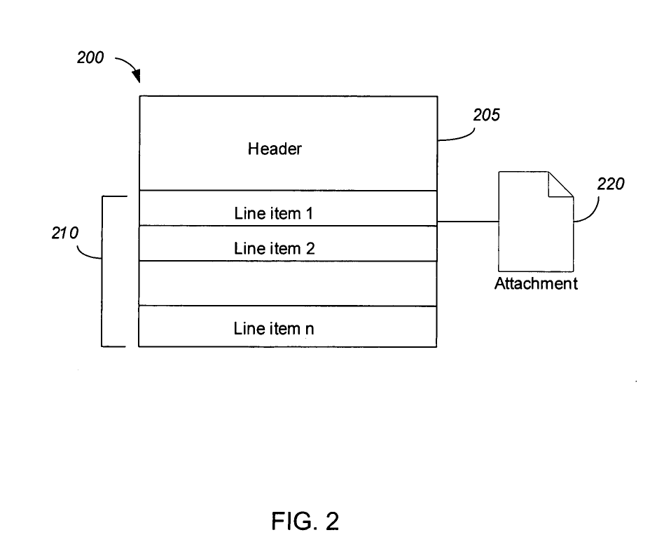

Reverse auctions may be represented as objects in the Bidding Engine application. The auctions may share a similar format 200, such as that shown in FIG. 2. An auction may include a header 205, one or more line items 210, and attachments 220. The header may include general information about the auction, such as a bidding rule profile, classification, terms and conditions, and duration. Line items identify products or services to be sourced. Attachments can be of any file type and can be added to line items in the auction.

The only price information in line items in the auction may be the unit price. However, purchasers may consider more than just the unit price when making a sourcing decision. Purchasers often need to take into account other factors associated with a supplier, such as shipping costs, taxes and tariffs, the supplier's reputation and history of on-time delivery, product quality, etc. These factors may represent collateral costs that will be associated with transactions with that particular supplier. The system may enable a form of bidding that can take these factors into consideration, i.e., factored cost bidding. Factored cost bidding allows purchasers to favor or handicap a bidder by automatically weighting the bidder's bid.

The collateral costs associated with the bidders in an auction may be factored into the bidding process using two types of factors: “adders” and “multipliers”. The purchaser is able to weight a bidder's bid in an auction using an adder or multiplier. This weighting is kept hidden from all of the bidders.

The value of the multiplier and/or adder assigned to a particular bidder may be pre-determined by the purchaser based on the importance of each of the criteria the purchaser wishes to consider. The multiplier and/or adder may be assigned to a bidder for each auction. Profiles for particular bidders may also be stored and modified.

An adder may be a positive or negative numeric value that is assigned to a bidder for a particular auction line item. All bids submitted by this bidder may be transformed by adding the adder value to the bid. While either a positive or negative value can be used for an adder, it may be desirable to use positive values only, and consider this positive adder as a form of handicap. For example, if a bidder submits a bid of $100 and has an adder equal to $5 (maybe due to extra delivery costs or quality issues), then other, un-handicapped bidders would see his bid as $105. A second un-handicapped bidder can outbid the first bidder by submitting a bid of $104, rather than $99. Thus, the adder acts as a handicap. Zero is the neutral value for an adder, i.e., the bidder is neither favored nor handicapped.

A multiplier may be a decimal value that is assigned to a bidder for a particular auction line item. All bids submitted by this bidder may be transformed by the bid by multiplying the multiplier. For example, if a bidder submits a bid of $100 and has a multiplier equal to 1.1, then other, un-handicapped bidders would see his bid as $110. A second un-handicapped bidder can outbid the first bidder by submitting a bid of $109, rather than $99. A multiplier with a value of 1 is the neutral number, i.e., the bidder is neither favored nor handicapped. For the purposes of this document, the multiplier is described as a floating-point number that is directly used to in multiplying by the bid amount. However, the user interface captures the information in the form of a percentage. If a user enters 100%, this represents a multiplier of 1.0. If the user enters 125%, this represents a multiplier of 1.25.

To favor a bidder, the value of the multiplier can be set to less than one. To handicap a bidder, the value of the multiplier can be set to a value greater than one. Decimal representations such as 1.25 may also be used (this would be entered as 125%)

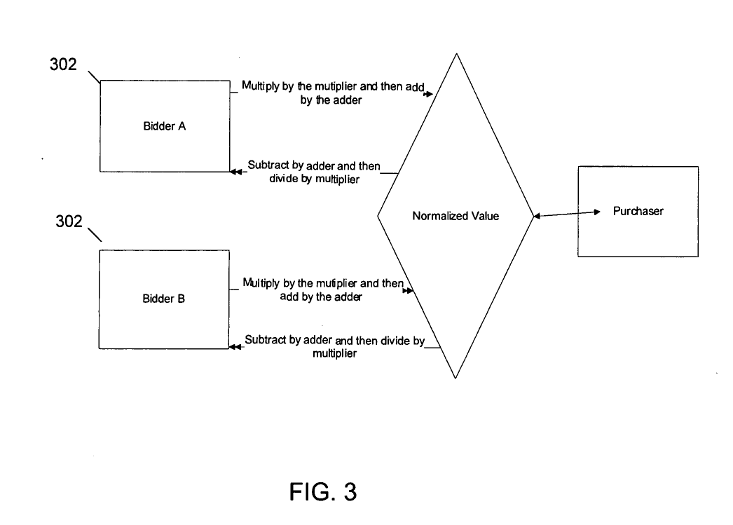

Adder(s) and/or multiplier(s) may be applied to a value entered by a bidder 302 (i.e., a “raw” bid value) to produce “normalized” and “transformed” values, as shown in FIG. 3. The normalized value is the value presented to the purchaser. The normalized value of a bid is the value of the bid after a single transformation, allowing a bid to be seen by the purchaser in the same context as other monetary auction fields (e.g., start price or reserve price). From the purchaser's perspective, normalizing the value of all bids allows the purchaser to view all bids “on a level playing field” so they can be more easily compared to each other, as well as compared with the start price or reserve price. The normalized value can be expressed using the following equation:
Normalized Value=(multiplierX*Bid amount)+adderX,

where “adderX” is the adder assigned to Bidder X and “multiplierX” is the multiplier assigned to Bidder X.

Transformed values are the values presented to the bidders. For bidders, the value is converted two times, both inbound and outbound. The transformed value can be expressed using the following equation:
Transformed Value=(Normalized Value−adderY)/multiplierY,

where “adderY” is the adder assigned to Bidder Y and “multiplierY” is the multiplier assigned to Bidder Y.

At a conceptual level, transformed values go through a double transformation, allowing a bid from one bidder to be “weighted” by his handicap, and allowing a second bidder to see this same bid “weighted” by his own, additional handicap. This double transformation mechanism allows a bid to be first normalized, and then converted to bidder-specific values (which can be different for each viewing bidder).

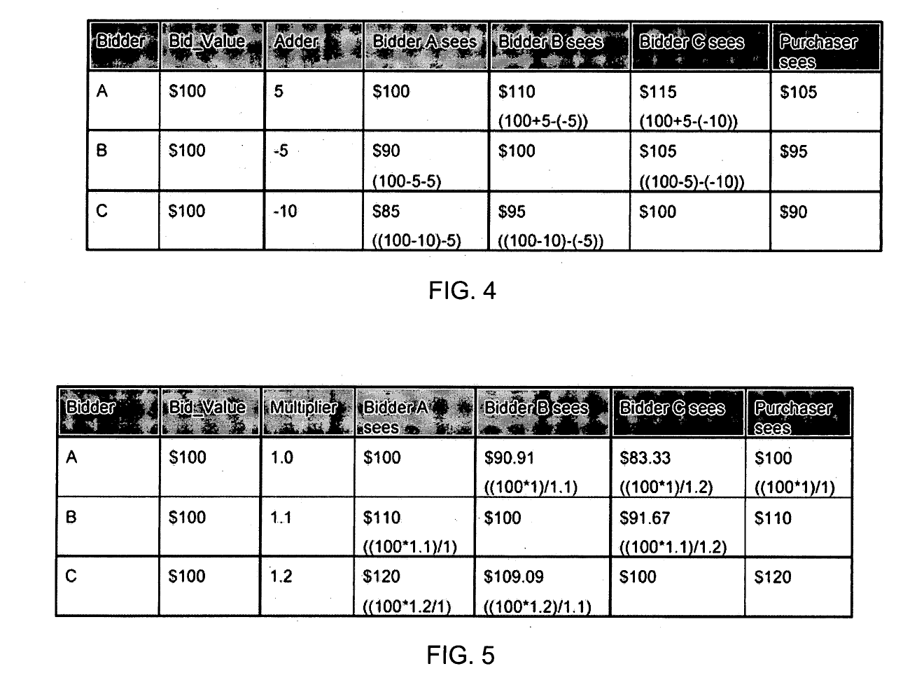

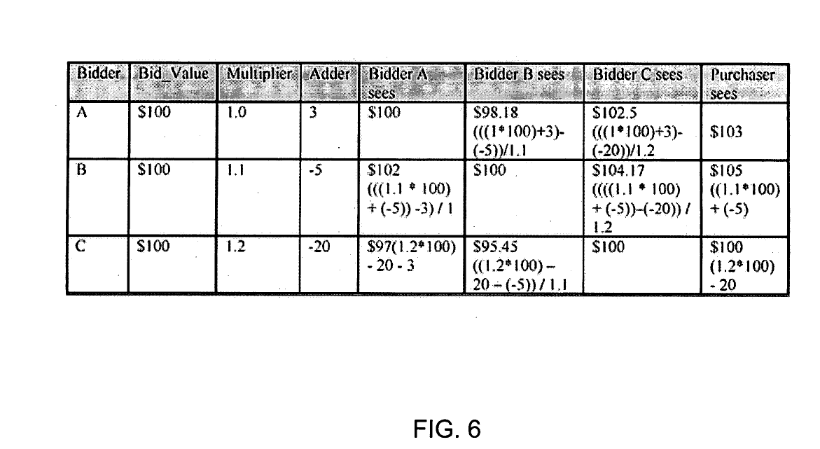

FIGS. 4-6 illustrate various factored bidding applications. FIG. 4 shows a case in which a negative/positive adders are used to favor/handicap bidders. FIG. 5 shows a case in which a positive multipliers are used to handicap bidders. FIG. 6 shows a case in which both adders and multipliers are used to favor/handicap bidders.

The purchaser may be able to see a bid from a particular bidder in either its raw value or “normalized” value via a toggle or filter in the user interface (UI). The purchaser may also see the multiplier(s) and/or adder(s) assigned to the bidders, which may affect the best bid and the bid history. The rest of the numeric values in the purchaser's UI may remain unchanged. For example, if the purchase entered a start price of $1000 and a bid decrement of $50, these values may be displayed to the purchaser throughout the auction.

A bidder may see the bid value he or she entered, i.e., the raw value, a transformed value for the start price of the auction item and the reserve price (if shown), and a next valid bid, which is a transformed value of the best bid. The bid decrement presented to the bidder should be transformed by the multiplier; however, the adder has no effect on the bid decrement because the offset remains the same regardless of the adder.

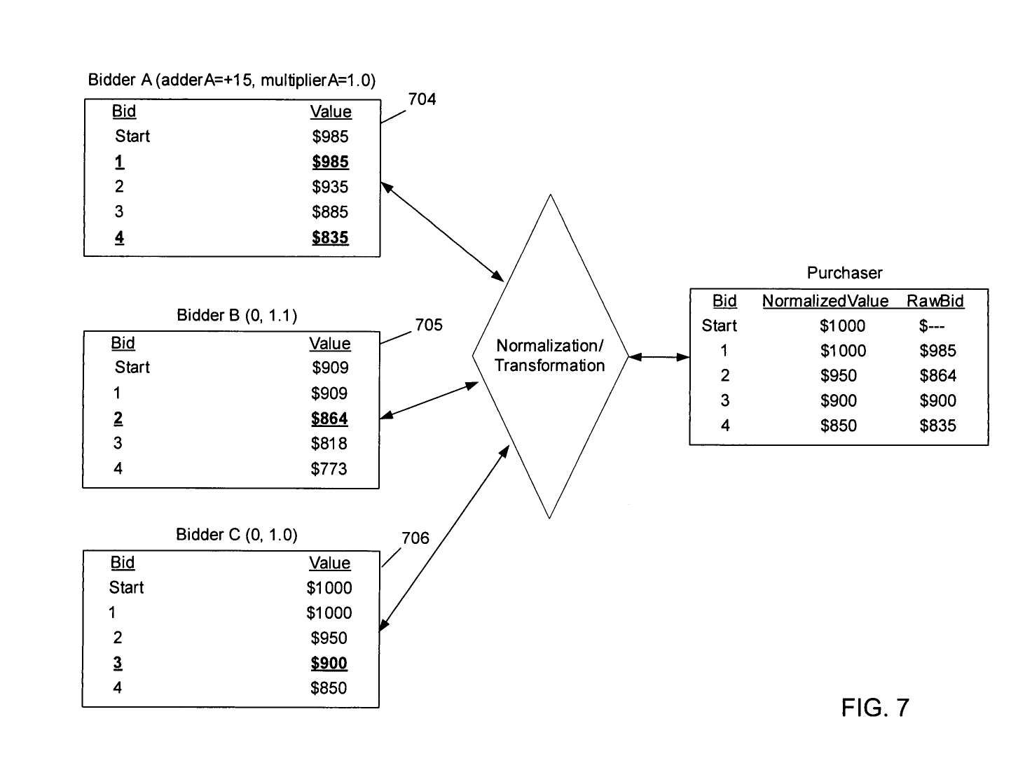

FIG. 7 shows views for auction participants in an exemplary auction employing factored cost bidding. The auction participants include a purchaser 702 and three bidders 704-706 (A, B, and C, respectively). In this example, Bidder A 704 is handicapped by an adder of +15, Bidder B 705 is handicapped by a multiplier of 1.1, and Bidder C 706 is neither favored or handicapped (i.e., assigned neutral values for adder (0) and multiplier (1.0)). In this example, the starting price for the line item is $1000 with a decrement of $50, and transformed values presented to the bidders are rounded to the nearest dollar.

Bidder A starts the bid at the starting price (Bid 1). Bidder A sees a transformed starting price of $985, Bidder B sees a transformed starting price of $909, and Bidder C sees a transformed starting price of $1000.

The next bid (Bid 2) is from Bidder B for a raw value of $864, which is the transformed starting price minus the transformed decrement value of $45. Bidder A sees Bidder B's bid as $935 and Bidder C sees Bidder B's bid as $950. The purchaser may see the normalized bid value of $950 and the raw bid value of $864.

The next bid (Bid 3) is from Bidder C for a raw value of $900. Bidder A sees Bidder C's bid as $885 and Bidder B sees Bidder C's bid as $818. The purchaser may see the normalized bid value of $900 and the raw bid value of $900.

The final bid (Bid 4) is from Bidder A for a raw value of $835. Bidder B sees Bidder A's bid as $773 and Bidder C sees Bidder A's bid as $850. The purchaser may see the normalized bid value of $850 and the raw bid value of $835.

In an embodiment, the adder(s) and/or multiplier(s) may be assigned by the purchaser per bidder company per auction line item. The system may disallow any changes on the assignment of the adder(s) and multiplier(s) once the auction has been activated.

The factored cost bidding technique is analogous currency conversion. For example, one way to convert Peso to Lira is to first convert from Peso to U.S. Dollars (USD) (i.e., normalize), then convert again from USD to Liras (i.e., transform). This may be done for mathematical simplicity. The conversion could also been done straight from Pesos to Liras, but this would require that all possible combinations of conversion factors would need to be known (e.g., consider 100 currencies and the possible combinations of conversions). By first normalizing and then transforming, the number of factors needed may be minimized.

In an embodiment, a benchmark figure, such as the price the purchaser's enterprise is currently paying for the line item being bid on, may be displayed to the purchaser. The purchaser may use this benchmarking figure for comparing bids in a live auction. The benchmarking figure may also be normalized by factors (adder/multiplier) associated with the current supplier of the item.

In another embodiment, the factored cost bidding technique can be used for forward auctions, in which case negative adder values and multipliers with values less than 1 would be handicapping factors.

The applications described herein (also known as programs, software, or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of embodiments have been described. Nevertheless, it will be understood that various modifications may be made without departing from the spirit and scope of the invention. Accordingly, other embodiments are within the scope of the following claims.

1. A method comprising:
assigning a factor to a first bidder;
receiving a bid for an item from the first bidder; and
performing an arithmetic operation on the bid using the factor to generate a normalized value.

2. The method of claim 1, wherein the factor comprises a multiplier value, and wherein said performing comprises:
multiplying the bid by the multiplier value to generate the normalized value.

3. The method of claim 1, wherein the factor comprises an adder value, and wherein said performing comprises:
adding the adder value to the bid to generate the normalized value.

4. The method of claim 1, wherein the factor comprises an adder value and a multiplier value, and wherein said performing comprises:
multiplying the bid by the multiplier value to generate a first value; and
adding the adder value to the bid to generate the normalized value.

5. The method of claim 1, further comprising:
displaying the normalized value to a purchaser.

6. The method of claim 5, further comprising:
displaying the bid to the purchaser along with the normalized value.

7. The method of claim 1, further comprising:
assigning another factor to a second bidder; and
performing an arithmetic operation on the normalized value using said another factor to generate a transformed value.

8. The method of claim 7, wherein said another factor comprises another adder value, and wherein said performing comprises:
subtracting said another adder value from the normalized value to generate the transformed value.

9. The method of claim 7, wherein said another factor comprises another multiplier value, and wherein said performing comprises:
dividing the normalized value by said another multiplier value to generate the transformed value.

10. The method of claim 7, wherein said another factor comprises another adder value and another multiplier value, and wherein said performing comprises:
subtracting said another adder value from the normalized value to generate a first value; and
dividing the first value by said another multiplier value to generate the transformed value.

11. The method of claim 7, further comprising:
displaying the transformed value to the second bidder.

12. The method of claim 1, wherein the factor operates to hinder the first bidder compared to one or more of a plurality of bidders.

13. The method of claim 1, wherein the factor operates to favor the first bidder compared to one or more of a plurality of bidders.

14. An apparatus comprising:
a normalization module operative to:
receive a factor assigned to a first bidder;
receive a bid from the first bidder; and
perform an arithmetic operation on the bid using the factor to generate a normalized value.

15. The apparatus of claim 14, wherein the factor comprises a multiplier value, and wherein the normalization module is operative to multiply the first value by the multiplier value to generate the normalized value.

16. The apparatus of claim 14, wherein the factor comprises an adder value, and wherein the normalization module is operative to add the adder value to the bid to generate the normalized value.

17. The apparatus of claim 14, wherein the factor comprises an adder value and a multiplier value, and wherein the normalization module is operative to:
multiply the bid by the multiplier value to generate a first value; and
add the adder value to the first value to generate the normalized value.

18. The apparatus of claim 14, wherein the normalization module is operative to transmit the normalized value to a purchaser for display.

19. The apparatus of claim 18, wherein the normalization module is operative to transmit the bid to the purchaser for display along with the normalized value.

20. The apparatus of claim 14, wherein the normalization module is further operative to:
receive an another factor assigned to a second bidder; and
perform an arithmetic operation on the normalized value using said another factor to generate a transformed value.

21. The apparatus of claim 20, wherein said another factor comprises another adder value, and wherein the normalization module is operative to:
subtract said another adder value from the normalized value to generate the transformed value.

22. The apparatus of claim 20, wherein said another factor comprises another multiplier value, and wherein the normalization module is operative to:
divide the normalized value by said another multiplier value to generate the transformed value.

23. The apparatus of claim 20, wherein said another factor comprises another adder value and another multiplier value, and wherein the normalization module is operative to:
subtract said another adder value from the normalized value to generate a first value; and
divide the first value by said another multiplier value to generate the transformed value.

24. The apparatus of claim 20, wherein the normalization module is operative to transmit the transformed value to the second bidder for display.

25. The apparatus of claim 14, wherein the factor operates to hinder the first bidder compared to one or more of a plurality of bidders.

26. The apparatus of claim 14, wherein the factor operates to favor the first bidder compared to one or more of a plurality of bidders.

27. An article comprising a machine-readable medium including machine-executable instructions operative to cause one or more machines to:
assign a factor to a first bidder;
receive a bid for an item from the first bidder; and
perform an arithmetic operation on the bid using the factor to generate a normalized value.
